(19) United States
(12) Patent Application Publication
(10) Pub. No.: US 2020/0325990 A1
(43) Pub. Date: Oct. 15, 2020

(54) STEERING COLUMN ASSEMBLY

(71) Applicant: TRW Limited, Solihull (GB)

(72) Inventors: Russell Wilson-Jones, Stratford-upon-Avon (GB); Mark Wilkes, Birmingham (GB)

(73) Assignee: TRW Limited, Solihull (GB)

(21) Appl. No.: 16/398,444

(22) Filed: Apr. 30, 2019

(30) Foreign Application Priority Data
Apr. 12, 2019 (GB) 1905212.5

(51) Int. Cl. F16J 15/3252; B62D 1/181; F16H 25/20

(52) U.S. Cl. CPC F16J 15/3252; F16H 2025/2031; F16H 25/20; B62D 1/181

(57) ABSTRACT

A steering column assembly includes a housing, a shaft, a sensor, a motor, an elongate rod, a nut member, an actuator housing, and end stops. The shaft may be attached to an end of a steering wheel. The sensor may generate an electrical signal in response to rotation of the rotatably mounted shaft. The motor may apply a torque to the rotatably mounted shaft. The elongate rod may be configured to rotate with the rotatably mounted shaft and may include an externally screw-threaded portion having a nut member mounted thereon. The actuator housing may define a chamber to house the motor and a cavity which restricts rotation of the nut member with respect to the housing. The rotation of the elongate rod causes axial displacement of the nut member. The end stops may engage with the nut member.

### TECHNICAL FIELD

The present invention relates to steering column assemblies and in particular, but not exclusively, to steering column assemblies for use with a steer-by-wire hand wheel actuator.

### BACKGROUND

In steer-by-wire arrangements, a hand wheel (steering wheel) is connected to one end of a shaft whose angular displacement is measured to generate a signal which is used to control the orientation of the steered wheels of the vehicle. Such arrangements are commonly also provided with an electric motor connected to the shaft to apply a torque in the opposite direction to the torque applied at the steering wheel in order to provide a sensation of road feel to the driver.

In steer-by-wire arrangements, it is important to limit the rotation of the steering wheel and the shaft to which it is connected to ensure that the maximum rotation of the steering wheel in both directions corresponds to the maximum pivoting of the steered wheels in both directions. If the rotation of the steering wheel is not limited, it would still be possible to rotate the steering wheel when the steered wheels are pivoted to their maximum pivoted angle, such that the rotational position of the steering wheel would no longer correspond to the position of the steered wheels.

One method of limiting the rotation of the steering wheel (and, in particular, the shaft to which the steering wheel is connected) is to provide a screw-threaded rod which rotates with the steering wheel, A nut is threadedly mounted on the screw-threaded rod and is prevented from rotating, whereby rotation of the steering wheel, and therefore the screw-threaded rod which rotates with it, results in longitudinal displacement of the nut along the screw-threaded rod. By providing end stops, the longitudinal displacement of the nut along the screw-threaded rod—and therefore the maximum rotation of the steering wheel in both directions—is limited,

However, it is important to ensure that the driver's steering feel is not harmed by any friction or inertia within the steering drive train. In particular, it is important to ensure that the longitudinal displacement of the nut along the screw-threaded threaded rod is not impeded as this would be felt by the driver and in an extreme situation the nut could seize or lock in position, which could prevent the driver from steering the vehicle.

It is an aim of the present invention to overcome or reduce the problems of such known steering column assemblies.

The above information disclosed in this Background section is only for enhancement of understanding of the background of the invention, and therefore, it may contain information that does not form the prior art that is already known in this country to a person of ordinary skill in the art. Accordingly, there is a need for a fuel injector assembly with improved thermal management performance,

### SUMMARY

The present disclosure provides a steering column assembly for a vehicle which includes a housing, a shaft, an elongate rod, a nut member, an elongate guide and end stops. The shaft may be rotatably mounted with respect to the housing and may be configured for attachment of a steering wheel at one end. The elongate rod may be configured to rotate with the rotatably mounted shaft and may include a screw-threaded portion. The nut member may be threadedly mounted on the screw-threaded portion of the elongate rod. The elongate guide for the nut member may restrict rotation of the nut member with respect to the housing, whereby rotation of the elongate rod causes axial displacement of the nut member along the elongate rod. The end stops may be positioned to engage with the nut member to define the maximum axial displacement of the nut member along the elongate rod in both directions. A clearance may also be provided between the elongate guide and the nut member.

By providing a clearance between the elongate guide and the nut member, misalignment of the screw-threaded rod is tolerated. In particular, it ensures that any runout in the screw-threaded rod will not cause the nut member to foul on the elongate guide, as any fouling would be felt by a driver and could cause the nut member to seize or otherwise lock in position.

In one embodiment, the elongate guide comprises a channel which receives the nut member. Preferably, the clearance between the channel and the nut member is achieved by making the channel oversized with respect to the nut member. This allows the nut member to rotate slightly with the screw-threaded rod until the nut member engages with the guide channel, after which further rotation of the screw-threaded rod results in longitudinal displacement of the nut member along the guide channel.

Preferably, the nut member is non-circular in cross section. The channel is preferably complementarily-shaped with the nut member, with a clearance between the channel and the nut member.

In one embodiment, the nut member comprises a plurality of faces. One or more of the faces of the nut member may be recessed. By providing a recess on one or more of the faces of the nut member, several lobes are effectively formed on the nut member, which are engageable with the guide channel.

Preferably, the elongate guide is located in the housing, and preferably, the elongate rod and the rotatably mounted shaft are coaxial. Similarly, the steering column assembly may also preferably further comprise a sensor configured to generate an electrical signal in response to rotation of the rotatably mounted shaft.

The steering column assembly may further comprises a motor configured to apply a torque to the rotatably mounted shaft in the opposite direction to an externally-applied torque. The nut member may be formed from a non-metallic material, for example a plastics material. The nut member may be formed from a material which is less dense than the screw-threaded rod. By having a nut member of low mass, the inertia of the nut transitioning from one direction to the other is low and will not be felt by the driver as any form of disturbance.

In accordance with a second aspect of the present invention, a steering column assembly for a vehicle may also be provided which includes a housing, a shaft, a sensor, a motor, an elongate guide channel, a nut member, an elongate guide, and end stops. The shaft may be rotatably mounted with respect to the housing and may be configured for attachment of a steering wheel at one end. The sensor configured to generate an electrical signal in response to rotation of the rotatably mounted shaft. The motor may be configured to apply a torque to the rotatably mounted shaft in the opposite direction to an externally-applied torque. The elongate rod may be arranged coaxially with, and configured to rotate with, the rotatably mounted shaft and comprising an externally screw-threaded portion. The nut member may be threadedly mounted on the screw-threaded portion of the elongate rod wherein the nut member may have a non-circular in cross section. The elongate guide channel in which the nut member is located, which restricts rotation of the nut member with respect to the housing, whereby rotation of the elongate rod causes axial displacement of the nut member along the rod, wherein the guide channel is coaxial with the elongate rod and is complementarily-shaped with the nut member with a clearance between the channel and the nut member. The end stops may be positioned to engage with the nut member to define the maximum axial displacement of the nut member along the elongate rod in both directions.

In the second embodiment, the nut member may also comprise a plurality of faces. The one or more of the faces of the nut member may optionally be recessed. The nut member may be formed from a non-metallic material, for example a plastics material. The nut member may be formed from a material which is less dense than the screw-threaded rod.

It is also understood that the present disclosure further includes a vehicle comprising a steering column assembly as described in any one of the embodiments above,

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 is a perspective view of an embodiment of steer-by-wire hand wheel actuator in accordance with the present invention;

FIG. 2 is a transverse cross section of the actuator of FIG. 1, looking in the direction of arrows II-II;

FIG. 3 is a longitudinal cross-section of the actuator of FIG. 1, looking the direction of arrows III-Ill of FIG. 2;

FIG. 4 is a longitudinal cross-section of the actuator of FIG. 1, looking the direction of arrows IV-IV of FIG. 2; and

FIG. 5 is a perspective view to an enlarged scale of a nut and leadscrew which form part of the actuator of FIG. 1.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about ” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It s also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any manner.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore there is no intention to be bound by any theory presented in the preceding background or the following detailed description.

A steer-by-wire hand wheel actuator 10 comprises an elongate metal steering column housing 12 and an actuator assembly 14 secured to one end of the steering column housing 12. A steering shaft 16 passes coaxially through the elongate metal housing 12 and in use a steering wheel (not shown) is connected to the outer end 18 of the steering shaft 16. The steering shaft 16 is rotatably supported on bearings (not shown) within the housing 12.

The inner end 22 of the steering shaft 16 is connected to a conventional torque/angle sensor 24 which produces electrical signals as a function of the rotational position of the steering wheel and steering shaft 16. The electrical signals are used in a known manner to control the angular position of the steered wheels of a vehicle in a steer-by-wire control arrangement.

The inner end 22 of the steering shaft 16 is also connected by means of a quill shaft 26 to an internally splined aperture 28 of a hub 32 to which a steering shaft pulley 34 is connected.

The hub 32 is rotatably mounted within the housing 14. The opposite end of the splined aperture 28 is enlarged and receives one end of a leadscrew 36 which is aligned coaxially with the steering shaft 16 and which is rotatably mounted by means of bearings 38, 40 within the actuator housing 43 of the actuator assembly 14 at its opposite ends.

An electric motor 42 is also mounted within the actuator housing 43 and is configured to drive output shaft 44 arranged parallel to the leadscrew 36 and to one projecting end of which an output pinion 46 is connected. A transmission belt 48 is fed around the output pinion 46 and around the steering shaft pulley 32, and the motor 42 is actuated to apply a torque, in order to provide feedback to the steering shaft 16 so as to produce a sensation of road feel to the driver. The applied torque is felt by the driver as a haptic feedback or to control the angle of the steering wheel.

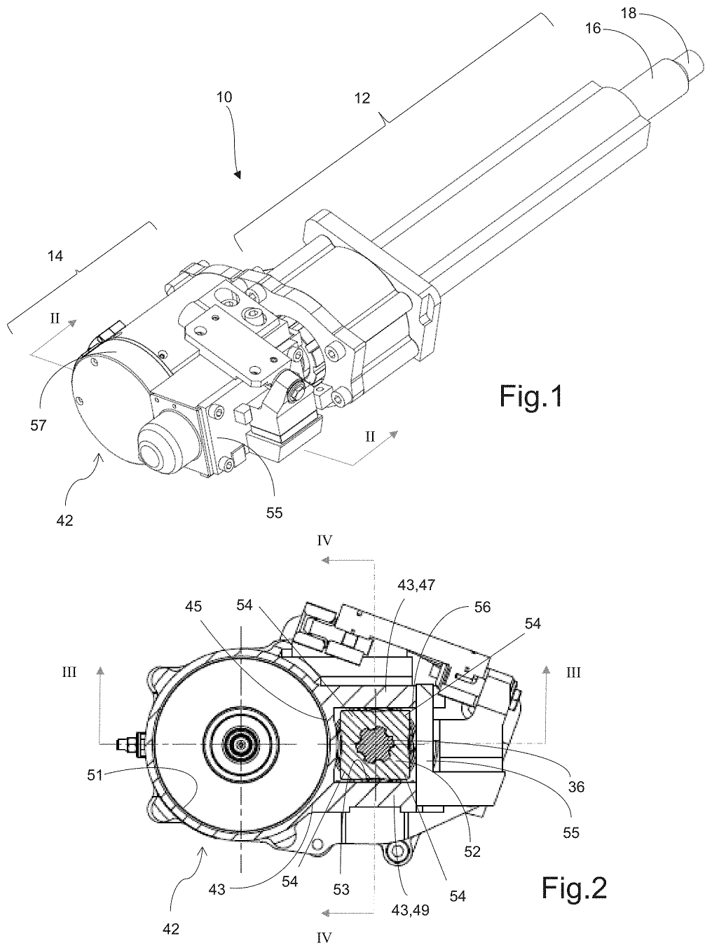

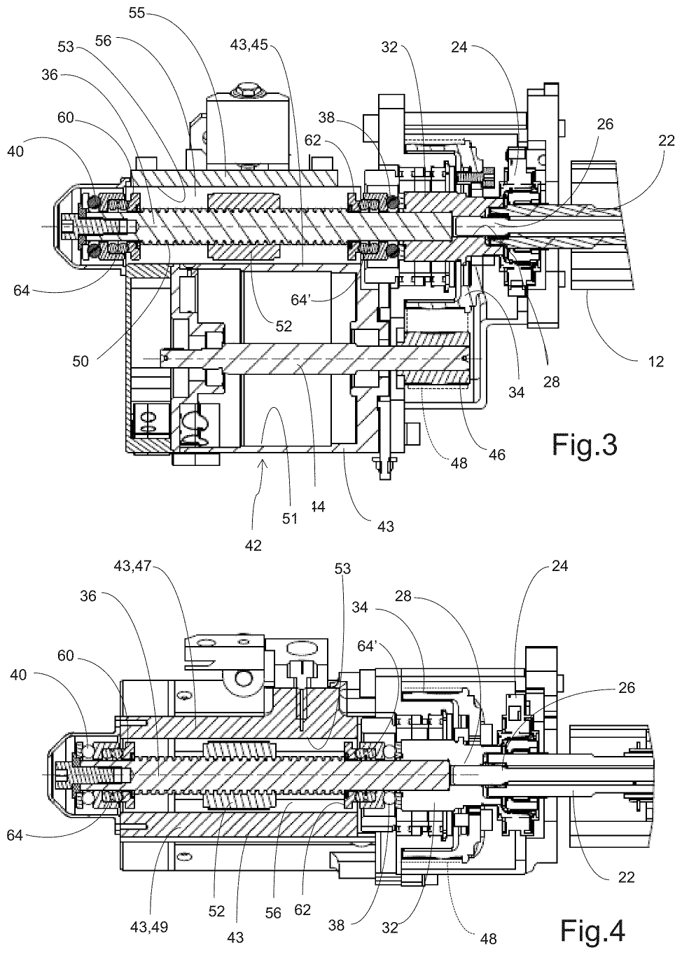

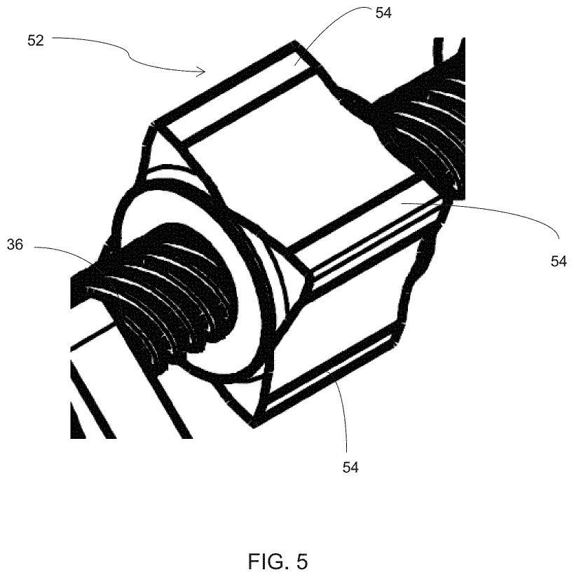

The leadscrew 36 is made from metal, for example steel, and is threaded for most of its length as shown at 50. Like the electric motor 42, a plastic leadscrew nut 52 is disposed within the actuator housing 43 (see FIGS. 2 and 4), The plastic leadscrew nut 52 is readily received on the threaded portion 50 of the leadscrew 36. Accordingly, as shown in FIGS. 2 and 3, the threaded portion 50 of the leadscrew 36 is similarly disposed within the actuator housing 43. The actuator housing 43 defines a chamber 51 for housing the electric motor 42 and a cavity 53 (adjacent to the chamber 51). The cavity 53 is configured to house the threaded portion 50 of the leadscrew 36 and the leadscrew nut 52. A dividing wall portion 45 of the actuator housing 43 is disposed between the chamber 51 and the cavity 53. As shown in FIG. 2, the cavity 53, the dividing wall portion 45, and the chamber 51 may be integral to each other in order to form the actuator housing 43. With reference to FIG. 2, the cavity 53 may include first and second wall portions 47, 49 which extend from the dividing wall portion 45. First cover 55 may be affixed to first and second wall portions 47, 49 of the actuator housing 43 during the assembly process in order to enclose the plastic leadscrew 52 within the actuator housing 43. Similarly, a second cover 57 may be separately provided as shown in FIG. 1 to easily enclose the electric motor 42 within the actuator housing 43 during the assembly process. The aforementioned arrangement of the actuator assembly 14 (electric motor 42, leadscrew 36 and leadscrew nut 52 relative to the actuator housing 43) requires minimal vehicle packaging space relative to traditional arrangements.

As best seen FIG. 2, nut 52 is generally square in cross section but its four faces are recessed slightly so that the four corners of the nut form lobes 54. As shown in FIGS. 2 to 4, the nut 52 is constrained to move within the cavity 53 which is provided in the form of an elongate channel 56 in FIGS. 2 and 3. As shown in FIGS. 2 and 3, the elongate channel 56 is defined by dividing wall portion 45 and first and second walls portions 47, 49 of the actuator housing 43. As shown, the elongate channel 56 may be generally square-shaped to at least partially constrain nut 52. However, the nut 52 is not a tight fit within the channel 56. Instead, the channel 56 is oversized with respect to the nut 52 (or the nut 52 is undersized with respect to the channel 56) so that there is a clearance between the nut 52 and the channel 56, such that the nut 52 is a loose fit in the channel 56.

As the leadscrew 36 is rotated by means of the steering shaft 16, the nut 56 can rotate slightly by a few degrees before it engages the walls of the channel 56. When the nut 52 is engaged with the walls of the channel 56, it is prevented from rotating further, and further rotation of the leadscrew 36 causes the nut 50 to be displaced longitudinally along the leadscrew.

The maximum displacement of the nut 52 along the leadscrew 56 is determined by first and second end stops 60, 62 located within the housing 14. A respective pair of rubber O-rings 64 is positioned behind each end stop 60, 62 in order to provide a damping effect, in order to cushion the contact between the nut 52 and the end stops 60, 62. Furthermore the end stops 60, 62 include thrust bearings 38, 40 which prevent the nut 52 from locking up when reaching the end of travel along leadscrew 56.

By providing a clearance between the channel 56 and the nut 52, any misalignment of the screw-threaded rod 36 is tolerated. In particular, it ensures that any runout in the screw-threaded rod 36 will not cause the nut 52 to foul on the walls of the channel 56, as any fouling would be felt by a driver and could cause the nut 52 to seize or otherwise lock in position.

In addition, by forming the nut 52 of lightweight material, for example plastics material, the driver's steering feel is not harmed by friction or inertia within the steering drive train. In addition, having a nut 52 of low mass assists in situations of steering reversal, as inertia when transitioning from one direction to the other is low and will not be felt by the driver as a disturbance. However, the nut 52 may be formed of other lightweight material or materials. For example, it may be formed of lightweight material or materials which are of a lower density than that of the screw-threaded rod 36 on which it is threadedly mounted.

The present disclosure may provide a steering column assembly having a housing 12, a shaft 16, a sensor 24, a motor 42, an elongate rod 36, a nut member 52, an actuator housing 43, and end stops 60, 62. The shaft 16 may be rotatably mounted with respect to the housing 12 and may be attached to the steering wheel at one end. The sensor 24 may generate an electrical signal in response to rotation of the rotatably mounted shaft 16. The motor 42 may apply a torque to the rotatably mounted shaft 16 in order to provide a haptic feedback to the driver, or to control the angle of the steering wheel. The elongate rod 36 may be arranged coaxially with, and configured to rotate with, the rotatably mounted shaft 16 and may include an externally screw-threaded portion 50. The nut member 52 may be threadedly mounted on the screw-threaded portion 50. The actuator housing 43 may define a chamber 51 to house the motor 42 and a cavity 53 in the form of an elongate guide channel 56 in which the nut member 52 is located, which restricts rotation of the nut member 52 with respect to the actuator housing 43. The rotation of the elongate rod 36 causes axial displacement of the nut member 52 along the rod 36, wherein the guide channel 56 or (elongated) cavity 53 is coaxial with the elongate rod 36 and is complementarily-shaped with the nut member 52 with a clearance between the channel and the nut member. The end stops 60, 62 may engage with the nut member 52 to define the maximum axial displacement of the nut member 52 along the elongate rod 36 in both directions.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A steering system for a vehicle comprising:
a housing defining an opening;
an input shaft configured to rotate about an input axis; and
a hybrid shaft support disposed at the opening and configured to couple the input shaft to the housing;
wherein the hybrid shaft support further includes a cylindrical member and a flexible seal over-molded to the cylindrical member.

2. The steering system as defined in claim 1 wherein the cylindrical member and the flexible seal each define an aperture configured to support the input shaft.

3. The steering system as defined in claim 2 wherein the cylindrical member is hollow and defines an inner wall surface configured to stabilize the input shaft and the housing against a side load.

4. The steering system as defined in claim 3 wherein the hybrid shaft support defines an outer rib, an inner rib and a recess defined between the outer rib and the inner rib.

5. The steering system as defined in claim 4 wherein the outer rib and the inner rib are configured to prevent debris from entering the housing via the opening.

6. The steering system as defined in claim 5 wherein the outer rib, the inner rib and the recess are defined in the flexible seal of the hybrid shaft support.

7. The steering system as defined in claim 6 wherein the hybrid shaft support further defines flange integral to a rigid body portion, the flange and the rigid body portion of the hybrid shaft support being configured to engage with the opening of the housing.

8. The steering system as defined in claim 7 wherein the cylindrical member defines a rigid flange portion integral to the rigid body portion.

9. The steering system as defined in claim 7 wherein the flexible seal defines a flexible flange portion which is overmolded onto the rigid flange portion.

10. The steering system as defined in claim 9 wherein the rigid flange portion is configured to structurally support the flexible flange portion against the housing.
